(19) United States
(12) Patent Application Publication
(10) Pub. No.: US 2021/0294404 A1
(43) Pub. Date: Sep. 23, 2021

(54) COMPUTER-IMPLEMENTED METHOD FOR CONTROLLING A UTILIZATION OF POWER PLANT CAPACITY OF A POWER PLANT

(71) Applicant: Robert Bosch GmbH, Stuttgart (DE)

(72) Inventor: Christian Heise, Aachen (DE)

(21) Appl. No.: 17/200,300

(22) Filed: Mar. 12, 2021

(30) Foreign Application Priority Data
Mar. 20, 2020 (DE) 102020203661.6

(51) Int. Cl. G06F 1/28; G06Q 20/36; G06Q 40/04; H02J 3/38

(52) U.S. Cl. CPC G06F 1/28; G06Q 20/363; H02J 2300/28; H02J 3/381; H02J 2300/24; G06Q 40/04

(57) ABSTRACT

A computer-implemented method for controlling a utilization of a power plant capacity of a power plant. The power plant capacity is divided into multiple portions. A particular portion of the power plant capacity is represented by a token. Use of the portion of the power plant capacity is determined by assignment of the token to a token wallet.

### CROSS REFERENCE

The present application claims the benefit under 35 U.S.C. § 119 of German Patent Application No. DE 102020203661.6 filed on Mar. 20, 2020, which is expressly incorporated herein by reference in its entirety.

### FIELD

The present invention relates to a computer-implemented method for controlling a utilization of the power plant capacity of a power plant.

### BACKGROUND INFORMATION

The increasing use of renewable energies often requires decentralized energy generation and thus results in an increased number of smaller power plants.

The control of the power plant capacity of multiple individual decentralized power plants is more comprehensive and complex as compared to the control of the power plant capacity of a single power plant. Sometimes it also provides a target for manipulation.

Therefore, it is desirable to provide a method, with the aid of which the utilization of the power plant capacity of a power plant may be controlled decentralized in a simplified and secure manner.

### SUMMARY

The present invention relates to a computer-implemented method for controlling a utilization of the power plant capacity of a power plant. In accordance with an example embodiment of the present invention, the power plant capacity is divided into multiple portions and any particular portion of the power plant capacity is represented by a token. The utilization of the portion of the power plant capacity is determined by assigning the token to a token wallet.

It is thus provided that a portion of the power plant capacity is assigned a purpose as a result of a token-based mechanism.

A token wallet is usually assigned to a person, so that the person, to whose token wallet the token is assigned that is represented by the particular token, determines the purpose of the portion of the power plant capacity.

A person may be a natural or a legal person.

A token wallet is understood to mean a type of a digital wallet, with the aid of which tokens may be kept, received, and transferred.

The method is suitable in particular to control the utilization of the power plant capacity of decentralized power plants.

The power plant capacity is advantageously divided into multiple equally sized portions, so that the tokens correspond to equally sized portions of the power plant capacity.

According to one preferred specific embodiment of the method in accordance with the present invention, a token is assigned in that the token is transferred into the token wallet of the person.

According to one preferred specific embodiment of the method in accordance with the present invention, an assignment of a token to a token wallet is registered in a register designed as a block chain system. The transferring is advantageously recorded in the register designed as a block chain system. In this way, the assignment of the tokens to a particular token wallet is verifiable and thus tamper-proof.

A register designed as a block chain system is a digital decentralized database structure that is controlled, in particular, by a distributed, public computer network. This is also referred to as a distributed ledger.

According to one preferred specific embodiment of the method in accordance with the present invention, a token fulfills a function of a digital asset, in particular of a digital right, the digital right including the decision about the purpose of the portion of the power plant capacity and the purpose including the consumption by the owner or third party consumption or trading, in particular. A token thus represents the right to determine the utilization of a certain portion of the actual capacity of a power plant.

According to one preferred specific embodiment of the method in accordance with the present invention, a particular token wallet is identified with the aid of an identification code of the token wallet.

According to one preferred specific embodiment of the method in accordance with the present invention, a particular token is identified with the aid of an identification code of the token. The identification code of the token allows for an unambiguous identification of a portion of the power plant capacity and for an unambiguous assignment of the portion to a power plant. The identification code includes for example information, for example geographic coordinates, which allows for an unambiguous assignment to a power plant.

According to one preferred specific embodiment of the method in accordance with the present invention, the power plant includes a wind power plant, a photovoltaic power plant, or a biomass power plant. The power plants of this type are frequently designed as decentralized plants due to the often low energy density, among other things.

Further preferred specific embodiments of the present invention relate to a computer program, the computer program including computer-readable instructions that, when they are carried out by a computer, prompt a method according to the specific embodiments to be carried out.

Further preferred specific embodiments of the present invention relate to a computer program product, the computer program product including a computer-readable memory medium, on which the computer program according to the specific embodiments is stored.

Further preferred specific embodiments of the present invention relate to a safety-relevant communication system, including a power plant and multiple persons as the communication participants that are represented by a particular token wallet, a power plant capacity of the power plant being divided into multiple portions and each portion being assigned a purpose by using a token-based mechanism, an assignment of a token to a token wallet being registered in a register designed as a block chain system with the aid of an identification code.

According to one preferred specific embodiment of the present invention, the safety-relevant communication system is designed to carry out a method according to the specific embodiments.

Renewable energy generators are quite expensive to purchase, therefore the introduction of decentralized renewable energy communities is slow and expensive. The method in accordance with the example embodiments of the present invention may therefore also be used in particular to carry out the financing process of such a power plant more easily and rapidly. With the aid of the method, the proprietary rights and the usage rights to a power plant or to the power plant capacity of the power plant may be managed with the aid of a token-based mechanism.

Investors in a power plant may be advantageously differentiated from the actual proprietors and/or users as a result of the application of the method.

Other features, application possibilities, and advantages of the present invention are derived from the following description of exemplary embodiments of the present invention, which are illustrated in the figures. All features described or illustrated represent the object of the present invention alone or in any arbitrary combination, regardless of their wording in the description or illustration in the figures.

### BRIEF DESCRIPTION OF THE DRAWINGS

FIG. 1 schematically shows a power plant.

FIG. 2 schematically shows a block diagram of a method for controlling a power plant in accordance with an example embodiment of the present invention.

### DETAILED DESCRIPTION OF EXAMPLE EMBODIMENTS

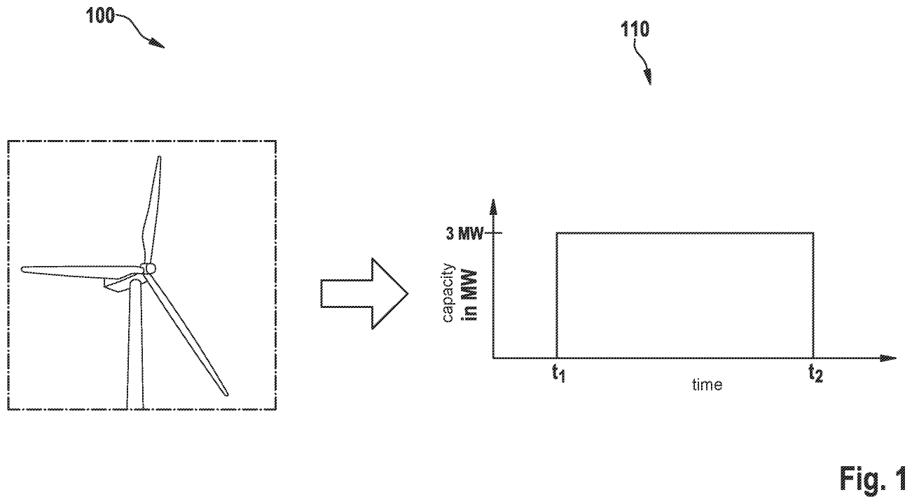

FIG. 1 schematically shows a power plant 100. According to the illustrated specific embodiment, power plant 100 is a wind power plant. Power plant 100 includes a power plant capacity 110. Power plant capacity 110 is the capacity rating, for example. According to the illustrated specific embodiment, power plant capacity 110 of the power plant is 3 MW, i.e., the maximal power plant capacity of power plant 100 is 3 MW.

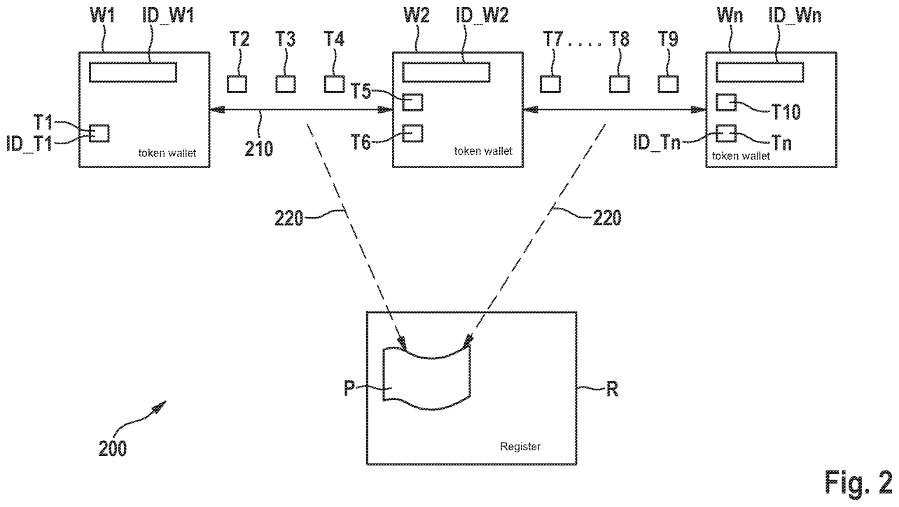

FIG. 2 schematically shows a block diagram of a method 200 for controlling power plant capacity 110 of power plant 100.

Power plant capacity 110 is divided into multiple portions and any particular portion of power plant capacity 110 is represented by a token T1, T2, . . . Tn, and the use for the portion of power plant capacity 110 is determined by assigning tokens T1, T2, . . . Tn to a token wallet W1, W2, . . . Wn.

A token wallet W1, W2, . . . Wn is usually assigned to a person, so that the person, to whose token wallet W1, W2, . . . Wn token T1, T2, . . . Tn is assigned that is represented by the particular portion of power plant capacity 110, determines the purpose of the portion of power plant capacity 110.

A person is a natural or a legal person, for example.

A token wallet W1, W2, . . . Wn is a type of a digital wallet, with the aid of which tokens T1, T2, . . . Tn may be kept, received and transferred.

Power plant capacity 110 is advantageously divided into multiple equally sized portions, so that tokens T1, T2, . . . Tn correspond to equally sized portions of power plant capacity 110. Power plant capacity 110 of power plant 100 may be divided into three thousand equally sized portions, for example, so that each token T1, T2, . . . Tn corresponds to a portion of 1 MW.

The assigning of a token T1, T2, . . . Tn to a token wallet W1, W2, . . . Wn takes place, for example, by transferring 210 token T1, T2, . . . Tn to token wallet W1, W2, . . . Wn of a particular person. The step of transferring tokens T2, T3 and T4 between token wallets W1 and W2 and transferring 210 of tokens T7, T8, T9 between token wallets W2 and Wn is illustrated in FIG. 2 through the arrows between the token wallets by way of example.

According to the illustrated specific embodiment of method 200, each assignment of a token T1, T2, . . . Tn to a token wallet W1, W2, . . . Wn is registered 220 in a register R designed as a block chain system. This process is illustrated in FIG. 2 by way of example in that each transfer of a token T1, T2, . . . Tn into a token wallet W1, W2, . . . Wn is recorded in a protocol P of register R designed as a block chain system. The step of registering 220 is illustrated in FIG. 2 through arrows 220 by way of example.

By registering 220, the assigning of tokens T1, T2, . . . Tn to a particular token wallet W1, W2, . . . Wn is verifiable and thus tamper-proof. Register R designed as a block chain system has a digital decentralized database structure that is controlled, in particular, by a distributed, public computer network.

According to the illustrated specific embodiment of method 200, a token T1, T2, . . . Tn fulfills a function of a digital asset, in particular of a digital right, the digital right including the decision about the purpose of the portion of power plant capacity 110 and the purpose including the consumption by the owner or third party consumption or trading, in particular. A token T1, T2, . . . Tn thus represents the right to determine the use for a specific portion of power plant capacity 110 of a power plant 100.

According to the illustrated specific embodiment, a particular token wallet W1, W2, . . . Wn is identified with the aid of an identification code ID_W1, ID_W2, . . . ID_Wn of token wallet W1, W2, . . . Wn. With the aid of identification codes ID_W1, ID_W2, . . . ID_Wn of token wallet W1, W2, . . . Wn, the natural and/or legal persons, to which the token wallets are assigned, are unambiguously identifiable.

According to the illustrated specific embodiment, a particular token T1, T2, . . . Tn is identified with the aid of an identification code ID_T1, ID_T2, . . . ID_Tn of token T1, T2, . . . Tn. Identification code ID_T1, ID_T2, . . . ID_Tn of token T1, T2, . . . Tn allows for an unambiguous identification of a portion of power plant capacity 110 and for an unambiguous assignment of the portion to a power plant 100. The identification code includes for example information, for example geographic coordinates of power plant 100, which allows for an unambiguous assignment to a power plant 100.

When registering an assignment of a token T1, T2, . . . Tn to a token wallet in register R designed as a block chain system, identification codes ID_T1, ID_T2, . . . ID_Tn of tokens T1, T2, . . . Tn and identification codes ID_W1, ID_W2, . . . ID_Wn of token wallets W1, W2, . . . Wn are registered.

Renewable energy generators are quite expensive to purchase, therefore the introduction of decentralized renewable energy communities is slow and expensive. The provided method may therefore also be used in particular to carry out the financing process of such a power plant 100 more easily and rapidly. With the aid of the method, the proprietary rights and the usage rights for power plant 100 or for power plant capacity 110 may be managed with the aid of a token-based mechanism.

Investors in a power plant 100 may be advantageously differentiated from the actual proprietors and/or users as a result of the application of the method.

This is elucidated below with reference to one example.

Person A would like to build a new power plant 100, in particular a wind power plant. Person A would like to finance the construction of power plant 100 through investors.

The power plant includes a power plant capacity 110 of 3 MW, for example. Person A offers three thousand tokens T1, T2, . . . Tn for purchase, for example, each token T1, T2, . . . Tn corresponding to a portion of 1/3,000 of power plant capacity 110. For this purpose, power plant 100 is transferred into the token wallet of the person and is now recognized in the register designed as a block chain system.

Third parties, investors in this case, may now purchase tokens T1, T2, . . . Tn. The purchase of tokens T1, T2, . . . Tn takes place by transferring tokens T1, T2, . . . Tn from the token wallet of person A into particular token wallet W1, W2, . . . Wn. In return, the purchaser of token T1, T2, . . . Tn obtains the right to determine the use of the portion of power plant capacity 110 of a power plant 100. The proprietor of token T1, T2, . . . Tn is thus able to define, how the energy will be used. The power plant capacity may be used, for example, for consumption by the owner or for third party consumption or also for trading, in particular temporarily.

Provided computer-implemented method 200 allows for a decentralized, fraud-resistant method 200 for controlling a utilization of a power plant capacity 110.

What is claimed is:

1. A computer-implemented method for controlling a utilization of a power plant capacity of a power plant, the method comprising:
dividing the power plant capacity is divided into multiple portions;
representing a particular portion of the multiple portions of the power plant capacity by a token; and
determining use of the portion of the power plant capacity by assigning the token to a token wallet.

2. The computer-implemented method as recited in claim 1,
wherein the assigning of a token takes place by transferring the token to a particular token wallet.

3. The computer-implemented method as recited in claim 1,
wherein the assignment of the token to the token wallet is registered in a register configured as a block chain system.

4. The computer-implemented method as recited in claim 1,
wherein the token fulfills a function of a digital right, the digital right including a decision about a purpose of the portion of the power plant capacity, the purpose including the consumption by an owner or third party consumption, or trading.

5. The computer-implemented method as recited in claim 1,
wherein the token wallet is identified using an identification code of the token wallet.

6. The computer-implemented method as recited in claim 1,
wherein the particular token is identified using an identification code of the token.

7. The computer-implemented method as recited in claim 1,
wherein the power plant includes a wind power plant, or a photovoltaic power plant, or a biomass power plant.

8. A computer-readable memory medium on which is stored a computer program for controlling a utilization of a power plant capacity of a power plant, the computer-program, when executed by a computer, causing the computer to perform:
dividing the power plant capacity is divided into multiple portions;
representing a particular portion of the multiple portions of the power plant capacity by a token; and
determining use of the portion of the power plant capacity by assigning the token to a token wallet.

9. A safety-relevant communication system, comprising:
a power plant; and
multiple persons as communication participants that are represented by respective token wallets;
wherein a power plant capacity of the power plant is divided into multiple portions and each portion is assigned a purpose by using a token-based mechanism, an assignment of a token to a token wallet of the token wallets being registered in a register configured as a block chain system using at least one identification code.

10. The safety-relevant communication system as recited in claim 9, wherein the safety-relevant communication system is configured to:
represent each respective portion of the multiple portions of the power plant capacity by a respective token; and
determine use of each respective portion of multiple portions of the power plant capacity by assigning the respective token to one of the token wallets.
